(19) United States
(12) Patent Application Publication
(10) Pub. No.: US 2025/0159276 A1
(43) Pub. Date: May 15, 2025

(54) SYSTEMS AND METHODS FOR GENERATING MEDIA-LINKED OVERLAY IMAGE

(71) Applicant: Adeia Guides Inc., San Jose, CA (US)

(72) Inventors: Serhad Doken, Bryn Mawr, PA (US); Jean-Yves Couleaud, Mission Viejo, CA (US); Ning Xu, Irvine, CA (US)

(21) Appl. No.: 18/508,034

(22) Filed: Nov. 13, 2023

(51) Int. Cl. H04N 21/431; G06V 20/40; H04N 21/44; H04N 21/4725

(52) U.S. Cl. CPC H04N 21/4316; G06V 20/41; H04N 21/44008; H04N 21/4725

(57) ABSTRACT

Methods and systems are disclosed for analyzing media content in response to a trigger, identifying relevant objects displayed within the media content, and generating linkable interactive user elements related to the relevant object that are presented as part of an overlay image for display on a user device. An image and a media content item are accessed and analyzed, interactive user elements are generated and used in an overlay image allowing selection of interactive user elements as a hyperlink to relevant content.

### BACKGROUND

The present disclosure relates to systems and methods for providing media linked images for media content. In particular, techniques are disclosed for analyzing media content in response to a trigger, identifying relevant objects displayed within the media content, and generating linkable interactive user elements related to the relevant object that are presented as part of an overlay image for display on a client device.

### SUMMARY

Media content, including media from streaming platforms, website-hosted videos, television shows, e-commerce websites, and the like, often depict objects or items for which additional related information is available. Additional information relevant to a depicted object may be found within the same content item at different time locations, or in other related media content. For example, when a client device plays a video review of a plurality of products, a system may offer user-interface elements for accessing additional segments of the video review that are relevant to one particular product. Further, it may be desirable for a system to provide access to content related to the particular product from an external source, such as a second video, a vendor website, a reference guide, and so on.

Providing a user interface that enables accessing relevant information quickly and with minimal effort can be challenging. One approach is to provide a user interface that is configured to allow manually navigating to related content, such as via a progress indicator to enable scrolling through the video until a relevant segment is found, or pausing the video to open up an internet browser, navigating to a search engine website, and entering a search query related to the product of interest. This approach is not automated and requires manual input and additional time and effort to present the relevant information.

Similarly, there is a desire to provide a user interface with easy access to additional relevant information related to objects within shown content. For example, when a video is uploaded to a video sharing platform, it may be desirable to provide easily accessible hyperlinks or bookmarks to additional relevant information to viewers of the content, either internally within the uploaded content or to external related content.

Further, when bookmarks or hyperlinks to additional related content are accessible and presented on an end user device, e.g., a user device or client device, coupling the bookmarks or hyperlinks with a related image, such as an image cutout of an object of interest that acts as a clickable link, allows for a user interface that provides suggested related content and the ability to jump to the suggested related content, e.g., to a relevant location within a video, with minimal effort.

In some current approaches, relevant hyperlinks to provide additional information are manually created. For example, a thumbnail for a video can be generated from an image file and then manually modified to include images of relevant objects. The images must then be further modified to incorporate hyperlinks to relevant content for convenient display on a client device. The locations of the hyperlinks are manually entered by adding a linked location to each image. This approach requires a multi-step manual process, including identifying relevant objects, creating images of the objects, creating image hyperlinks to related content, and uploading the image hyperlinks to be accessible on a user device while the content is being shown. Thus, there is a need for an automated and streamlined method for identifying objects of interest in a media content item and generating relevant links to display along with the media content item on a user device.

In some embodiments, a media server accesses and analyzes media content items, such as a video, to determine relevant objects depicted therein. The media server generates an overlay image containing interactive user elements, such as clickable links directed toward additional content related to the relevant objects, based on the analysis. The media server may implement the overlay image as a thumbnail for the media content, an enhanced pause screen, an icon representing the video, and the like. In response to a user interface input selection of an interactive user element, the media server causes to be displayed, e.g., on a client device, additional relevant information.

In an embodiment, the media server generates the overlay image when a video file is uploaded, e.g., received by the media server of a video streaming service from an uploading client device. Upon upload, or at a predetermined time, the media server analyzes the video to identify relevant objects, and generates an overlay image with an interactive user element that is representative of the relevant objects. For example, if the subject of the video is a review of multiple lenses for a digital camera, each lens is identified as a relevant object, and the server generates an interactive user element for each lens, where each interactive user element links to one or more locations within the video that discusses that particular lens.

In some embodiments, the video file is uploaded from a first user device to a media server, such as a file sharing service server or a video streaming server. The media server is configured to initiate an analysis of the video file when the upload is received. An image is uploaded from the first user device along with the video file and received by the media server, and both the video file and the image are analyzed by the media server to identify relevant objects depicted therein. In an embodiment, the analyzed image is one or more frames extracted from the uploaded video file. The resulting generated overlay image is caused to be displayed, by the media server, on a second user device, e.g., when a request from the second user device to display the video is received by the video streaming server.

Continuing with the same example, in a further embodiment, an image file displaying each of the reviewed lenses is uploaded along with the video file as a thumbnail image and received by the media server. The thumbnail image is analyzed by the media server along with the video to identify each of the reviewed lenses. An interactive user element for each lens is generated and positioned over each of the lenses within the thumbnail image. Thus, a modified thumbnail image is generated showing each of the lenses, with an interactive user element positioned over each lens shown. When a user input selecting one of the interactive user elements of a lens is received, the video begins to play on the user device at a position relevant to that particular lens.

In a further embodiment, the media server generates the overlay image when a pause command is received, e.g., from a client device, during playback of the video. A video frame, e.g., the frame displayed when the pause command was received, is captured and analyzed by the media server to identify objects depicted therein. The video file is analyzed to identify relevant locations within the video that relate to the identified objects, and interactive user elements linking to the relevant playback locations are generated and displayed on an overlay image that is presented as a modified pause screen on a user device. In a further embodiment, the analysis of the video frame and video file is initiated when a period of inactivity exceeds a predetermined threshold.

In an embodiment, the generation of the overlay image is initiated by the media server when a search command is received from a user device during a play operation of a video content item. For example, while displaying a video, a user interface displays a search function option as a graphical icon to initiate a search of the current frame or all video frames within a predetermined period of time, e.g., 10 seconds before and 10 seconds after the search request is received. One or more frames of the video content item is accessed and analyzed by the media server to identify a relevant object depicted therein, and an overlay image containing interactive user elements with links directed toward additional content related to the relevant object within the video content item is generated for display. In some embodiments, some or all of the frames of the video content item are analyzed upon receiving an upload of the associated video files, e.g., to the media server, to identify objects, and the identified objects are indexed and stored for future reference. The indexing of the identified objects may be limited to object types that appear most frequently, such as camera lenses in the aforementioned example. The stored index may be converted into, or associated with, metadata of the video content item, and upon receiving a pause command, the index may be accessed and used to generate the image and hyperlinks discussed herein.

In a further embodiment, an external database is accessed by the media server, the database comprising metadata related to relevant objects associated with media content that is not the initially accessed media content. The media server is configured to search the external database for relevant media content in addition to, or instead of, determining internal links within the initial media content. External media content can include other videos on the same platform currently displaying the initial media content, content hosted on or related to different platforms, different media content, such as websites, documents, video files, and the like.

In yet a further embodiment, the media server is configured to determine that an identified relevant object is depicted in a video file in a distorted presentation. A non-distorted version of the object is generated by the media server, e.g., by using generative artificial intelligence, by comparing the distorted presentation of the object with a non-distorted version shown in another frame of the video file, and the like, and the interactive user element of the overlay image file includes the non-distorted version of the object.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative embodiment of generating for display an overlay image with interactive user elements in response to receiving a media content upload, in accordance with some embodiments of the disclosure.

FIG. 1B shows an illustrative embodiment of generating for display an overlay image with interactive user elements in response to receiving a pause command, in accordance with some embodiments of the disclosure.

FIG. 1C shows an illustrative embodiment of generating for display an overlay image with interactive user elements in response to receiving a search command, in accordance with some embodiments of the disclosure.

FIG. 2 shows an illustrative network diagram of a system for generating for display an overlay image with interactive user elements, in accordance with some embodiments of the disclosure.

FIG. 3 is a flowchart of a process for generating for display an overlay image with interactive user elements, in accordance with some embodiments of the disclosure.

FIG. 4 is a flowchart of a process of generating for display an overlay image with interactive user elements in response to receiving a pause command, in accordance with some embodiments of the disclosure.

FIG. 5 is a flowchart of a process of generating for display an overlay image with interactive user elements in response to receiving a search command, in accordance with some embodiments of the disclosure.

FIG. 6 depicts illustrative thumbnail images of a video content item, in accordance with some embodiments of the disclosure.

FIG. 7 depicts illustrative thumbnail images of a video content item with distorted and non-distorted images of relevant objects, in accordance with some embodiments of the disclosure.

FIG. 8 is a block diagram showing components of a device for generating for display an overlay image with interactive user elements, in accordance with some embodiments of the disclosure.

### DETAILED DESCRIPTION

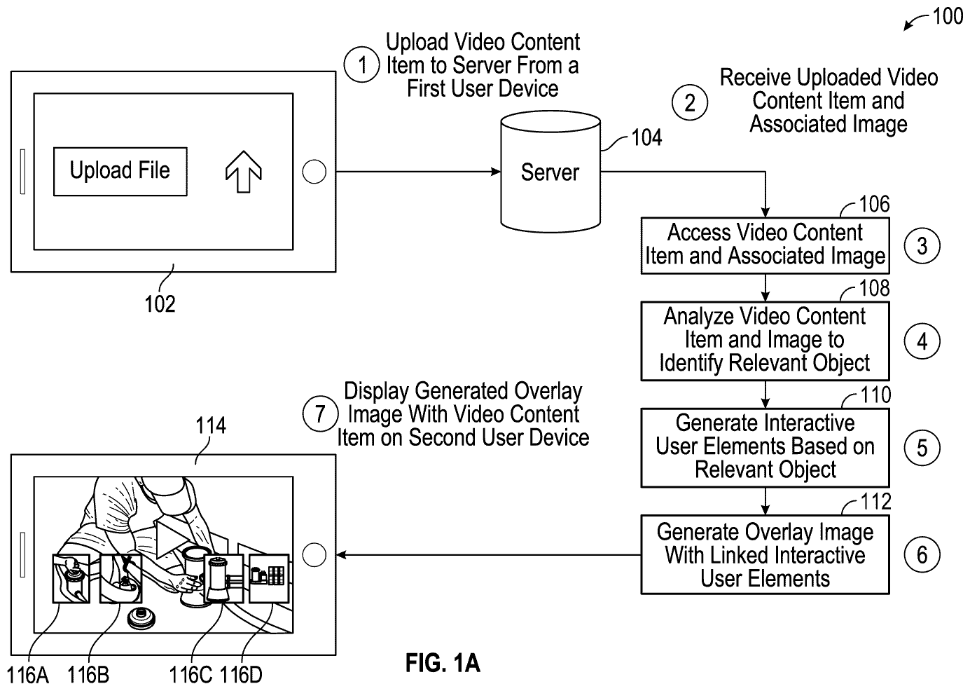

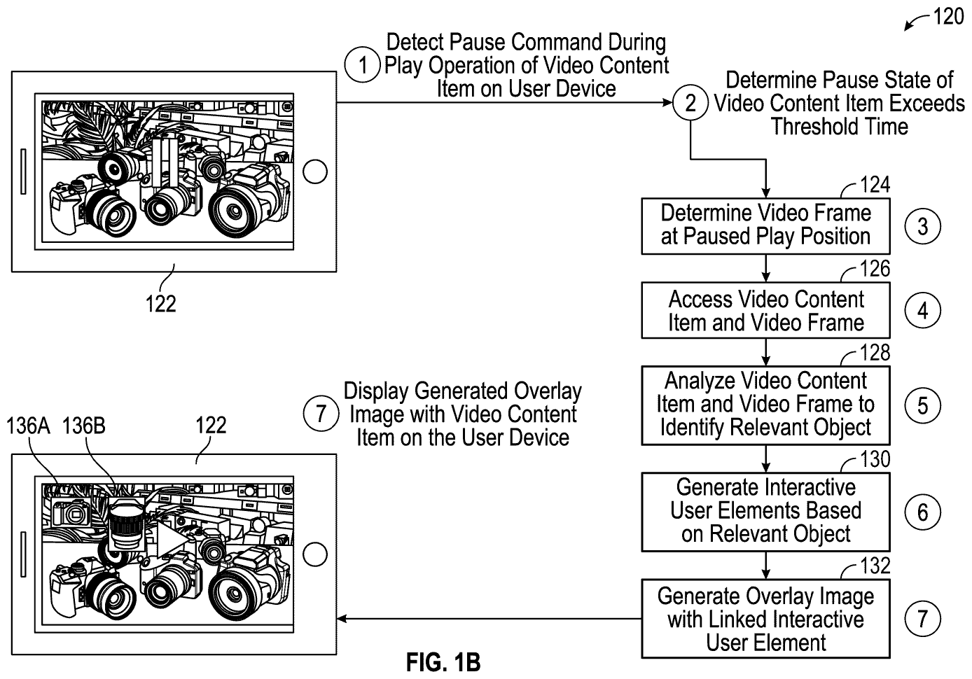

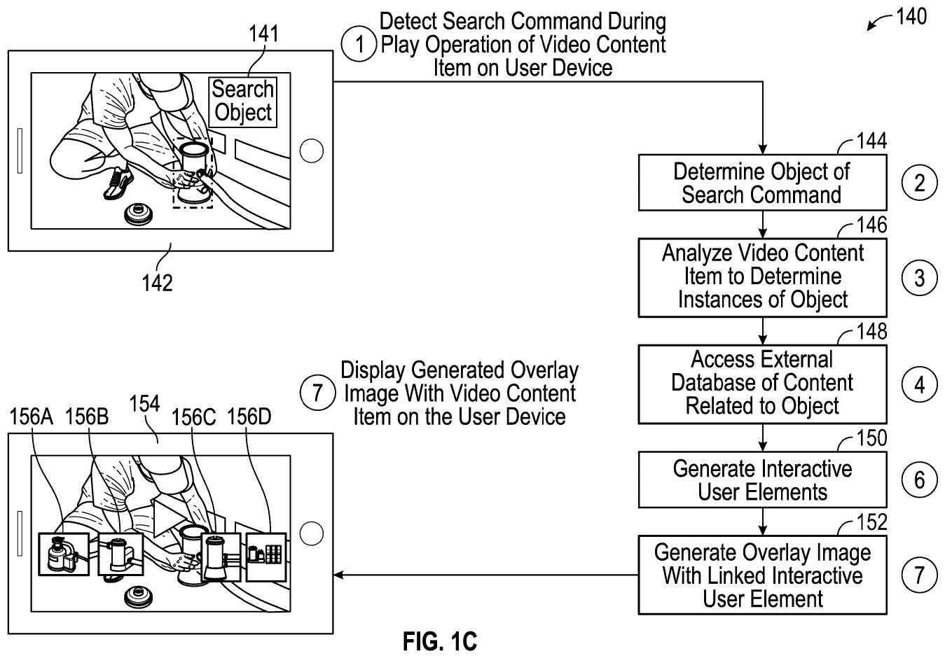

FIGS. 1A-1C show illustrative examples of generating for display an overlay image with interactive user elements in response to a triggering event. While FIGS. 1A-1C depict a media content item that is a video, it should be appreciated that the present disclosure is applicable to any media content item, such as streaming video from a streaming service, live or non-live broadcast television, live or non-live over the top (OTT) television, images or video from a social media platform, images or video reviews from an e-commerce website, media related to instructional or educational information, and the like, or any combination thereof.

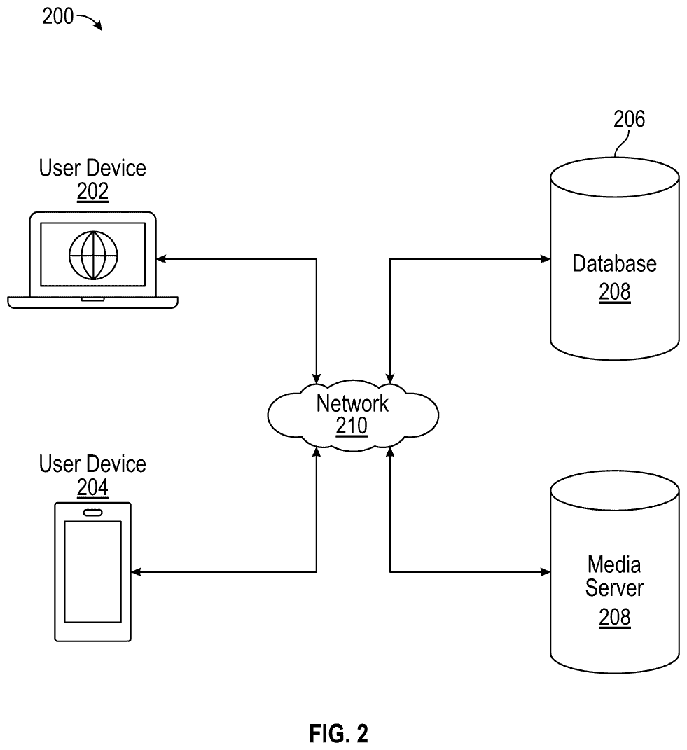

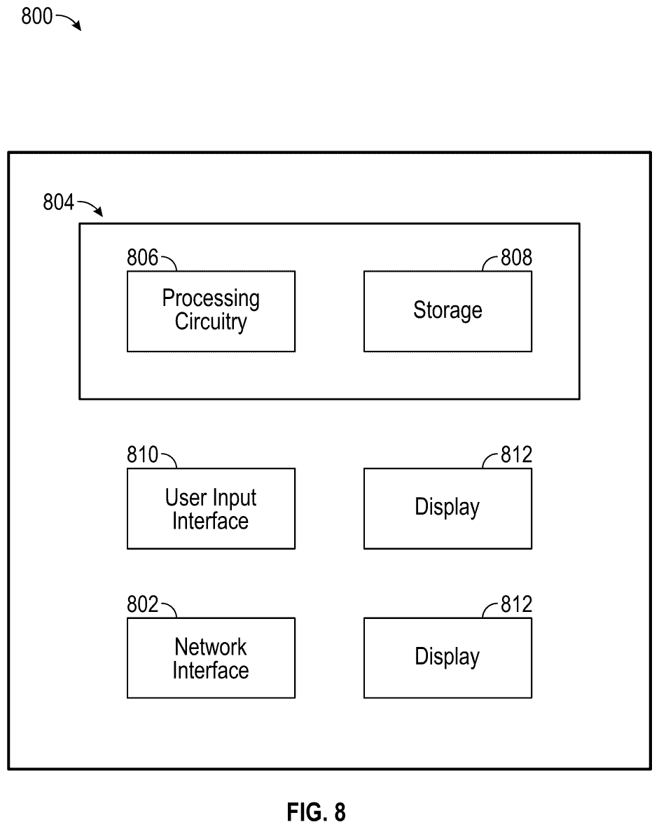

In some embodiments, the generation of an overlay image with interactive user elements is performed at least in part on a computing device and/or at one or more remote servers and/or distributed across any of one or more other suitable computing devices, in communication over any suitable number and/or types of networks (e.g., the internet). The computing device may be configured to perform the functionalities (or any suitable portion of the functionalities) described herein. In further embodiments, the generation of an overlay image with interactive user elements is performed by a software application executed on control circuitry, such as control circuitry 804 of FIG. 8, and may be control circuitry of user device 202, user device 204, media server 207 of FIG. 2, and the like.

As referred to herein, the terms “media content item,” “media content,” “media,” and “content” may be understood to mean electronically consumable user assets, such as images, video clips, video content stored across multiple files (e.g., employing HTTP Live Streaming (HLS) streaming protocol, 3D content, television programming, on-demand programs (as in video-on-demand (VOD) systems), live content, internet content (e.g., streaming content, downloadable content, webcasts, etc.), content information, GIFs, rotating images, documents, playlists, websites, articles, books, electronic books, blogs, advertisements, chat sessions, social media, applications, games, and/or any other media or multimedia and/or combination of the same. Media content may be recorded, played, transmitted to, uploaded from, created by, processed, displayed and/or accessed by a computing device, such as a user device or a media server. In some embodiments, the media content may be generated for display from a broadcast or stream received at a computing device, or from a recording stored in a memory of the computing device and/or a remote server.

FIG. 1A shows an illustrative embodiment 100 of steps for generating for display an overlay image with interactive user elements in response to receiving a media content upload, in accordance with some embodiments of the disclosure. A server 104, e.g., the media server 206 of FIG. 2 shown below, receives an upload of a media content item, such as a video file, from a first user device 102. In an embodiment, an associated image received by the server from the first user device 102 in conjunction with the video file. In a further embodiment, the server receives the video file without an associated image, and an image associated with the video file is accessed by the server 104, e.g., from an image database. In yet a further embodiment, the server extracts an image from the video file, e.g., a video frame from the video file.

Upon receiving the uploaded video file, the server is configured to access 106 the video file and an associated image. The server analyzes the video file and image 108 to identify an object and a portion of frames of the video file that are relevant to the identified object. The server generates one or more interactive user elements 110 based on the identified object and frames of the video file. In an embodiment, the media server is configured to generate a compound image containing all the objects of interest in the video based off a plurality of identified objects extracted from a plurality of frames within the video file. The interactive user element includes a digital reference, or hyperlink, to relevant frame(s) or frame range(s) within the video file, e.g., where the identified object is depicted, discussed, or otherwise referenced. The server generates an overlay image including one or more interactive user elements 116A-116D, and causes the overlay image to be displayed on a second user device 114. The second user device may display the overlay image in response to receiving a user interface input, such as a pause command, a search command, a selection of the video file or of a portion of the video file, a selection of a thumbnail of the video file, and the like. In a further embodiment, the overlay image is displayed in response to receiving an input to play the video file or a portion thereof.

In an embodiment, a playlist of different frames or segments, and/or different frame or segment ranges, is generated and played in response to receiving the user interface input selection of the interactive element. For example, a file, such as a manifest file, is generated in response to the video file and image analysis, where the file specifies the frames and/or segments to be played in a specific order. The playback order may be the same order or a different order than that of the original video file, e.g., a first instance of the object within the video file may not be played first, or at all, if later instances of the object provide a better, clearer, or less obstructed view of the object, a more detailed discussion of the object, and the like. Further, multiple frames and/or segments of the video file or of other relevant media can be stitched together to create a sequence that can be stored as a separate media file or as metadata representing relevant identified sections that is accessed and used to generate a relevant sequence of frames and/or segments on a user device. The method for generating and causing to be displayed the overlay image including the interactive user element is described in further detail in the discussion of FIGS. 2-5 below.

FIG. 1B shows an illustrative embodiment 120 of steps for generating for display an overlay image with interactive user elements in response to receiving a pause command, in accordance with some embodiments of the disclosure. As discusses above regarding FIG. 1A, a media server may perform the method discussed here. As shown in FIG. 1B, the server, e.g., a streaming server, receives a pause command from a user device 122 currently playing a video content item. In an embodiment, the method only proceeds after the server determines that a period of time of inactivity in a paused state exceeds a predetermined threshold. The server accesses an image associated with the video content item. In an embodiment, a video frame being displayed when the pause command was received by the streaming server, or of a nearby frame, is identified 124 by the server, and the image is a screenshot of the video frame of the video content item.

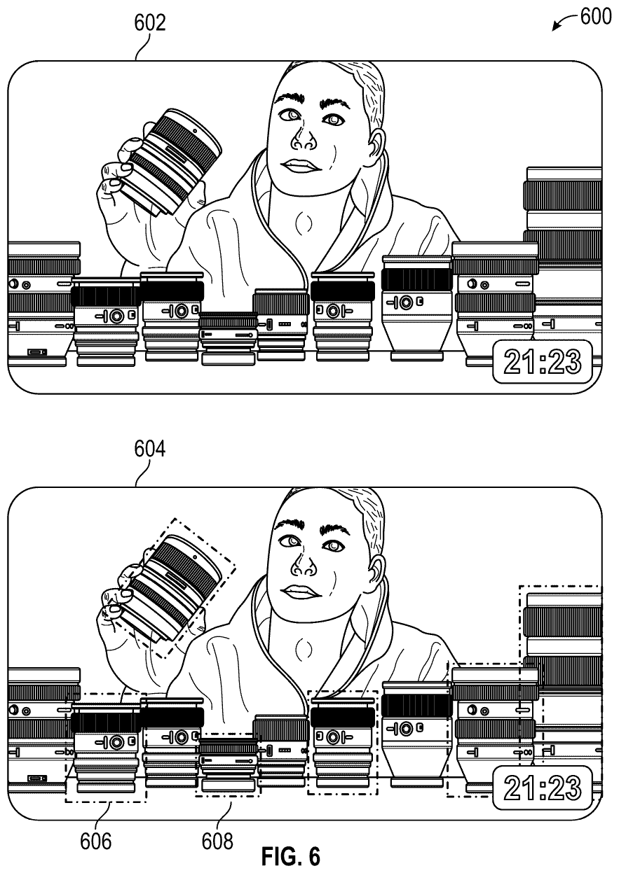

The server analyzes the video content item and associated image 128 to identify a relevant object depicted in the frame and to identify other frames within the video content item related to the relevant object. In an embodiment, the server analyzes the video content item upon receiving an initial upload of an associated video file or files to identify one or more relevant objects depicted therein and creates an index which can be accessed when a pause command is received. For example, if the video content item is a video review of a plurality of camera lenses, and the video frame is a frame of the video content item displaying all of the plurality of camera lenses, e.g., as shown in FIG. 6, video frames or segments related to each of the plurality of camera lenses are identified by the server. An interactive user element is generated by the server for the identified video frames. In an embodiment, an interactive user element is generated for each instance of an identified relevant frame or sequence within the video content item. In a further embodiment, if an identified relevant object appears multiple times within the video content item, frames or sequences of particular interest are identified and an interactive user element is generated for each frame or sequence of particular interest. For example, if a particular camera lens is discussed five times within a video review, and only two of those instances are determined to be instances of relevance, only two interactive user elements are generated with a hyperlink pointing to the frame at the beginning of each of the two relevant instances, and no interactive user elements are generated for the remaining three non-relevant instances.

In an embodiment, the interactive user element is a hyperlink pointing to a related video frame. Continuing in the above example, the video review may include a section devoted to each of the reviewed camera lenses, e.g., segment for camera lens #1 at 1 min and 20 second into the video review, segment for camera lens #2 at 2 min and 40 second into the video review, segment for camera lens #3 at 4 min and 50 second into the video review, and the like. Thus, the server generates an interactive user element 136A, 136B for each segment 130. An overlay image including each of the generated interactive user elements 136A and 136B is generated for display 132, e.g., as a pause screen for the video content item shown on the user device, and the generated overlay image is caused to be displayed, by the server, on the user device 122. Finally, in response to a user interface input selection of an interactive user element 136A or 136B, the relevant segment of the video content item is shown on the user device 122.

In a further embodiment, at least a part of the video file and image analysis is performed at a previous time, e.g., when a video file is uploaded to a media server as discussed above in relation to FIG. 1A, and an index or data structure referencing relevant frames or segments of the video file is created and stored, e.g., in a database, for future access. In response to receiving an interface command, such as a pause or search command, the previously generated index or data structure is accessed and the interactive user elements 136A and 136B are generated and/or displayed based on the index or data structure.

FIG. 1C shows an illustrative embodiment 140 of steps for generating for display an overlay image with interactive user elements in response to receiving a search command, in accordance with some embodiments of the disclosure. As shown in FIG. 1C, the server received a search command, e.g., from a user device 142 currently playing a video content item. An image associated with the video content item is accessed by the server. In an embodiment, the image is a screenshot of the frame of the video content item being displayed when the search command was received by the streaming server, or of a nearby frame.

The server further analyzes the image 144 to identify an object relevant to the search command. In an embodiment, the search command includes additional information that can be used to identify the object. For example, the search command may include data relating to a user interface input identifying a portion of the image. In an embodiment, the search command requires the selection of a portion of a frame of the video content item, e.g., via a drag or draw function to place a box around an object; clicking, right-clicking, or tapping on an object; using a keyboard or other input device to highlight the object; and the like, where the object identification is limited to the selected portion. In a further embodiment, the video content item includes metadata describing objects depicted within the video content item and time location within the video content item relating to the depicted objects, where the metadata is used to identify the object selected in the search request.

The server analyzes the video content item 146 to identify frames within the video content item related to the identified object. One or more interactive user elements 156A-156D are generated 150 based on the identified video frames. In an embodiment, the interactive user elements 156A-156D are hyperlinks pointing to a related video frame or the beginning of a relevant segment. For example, an interactive user element may be a hyperlink to the next instance within the video content item in which the identified object is depicted. An overlay image including the generated interactive user elements 156A-156D is generated for display 152, e.g., as an overlay image displayed alongside the video content item on the user device 142. Finally, in response to a user interface input selection of one of the interactive user elements 156A-156D, the relevant video frame is shown on the user device 142.

FIG. 2 shows an illustrative network diagram 200 of a system for generating for display an overlay image with interactive user elements, in accordance with some embodiments of the disclosure. The system includes a first user device 202, a second user device 204 (each of which may correspond to, e.g., user device 102, 114, 122, and 142 of FIGS. 1A-1C), and a media server 206 that are connected via a communication network 210. In an embodiment, the system further includes a database 208. The user device 202, user device 204, and media server 206 are coupled to communications network 210. Communications network 210 is used by the device 202 to upload a media content item, such as a video file or an image file, to the media server 206.

Communication network 210 may comprise or correspond to one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 210) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths.

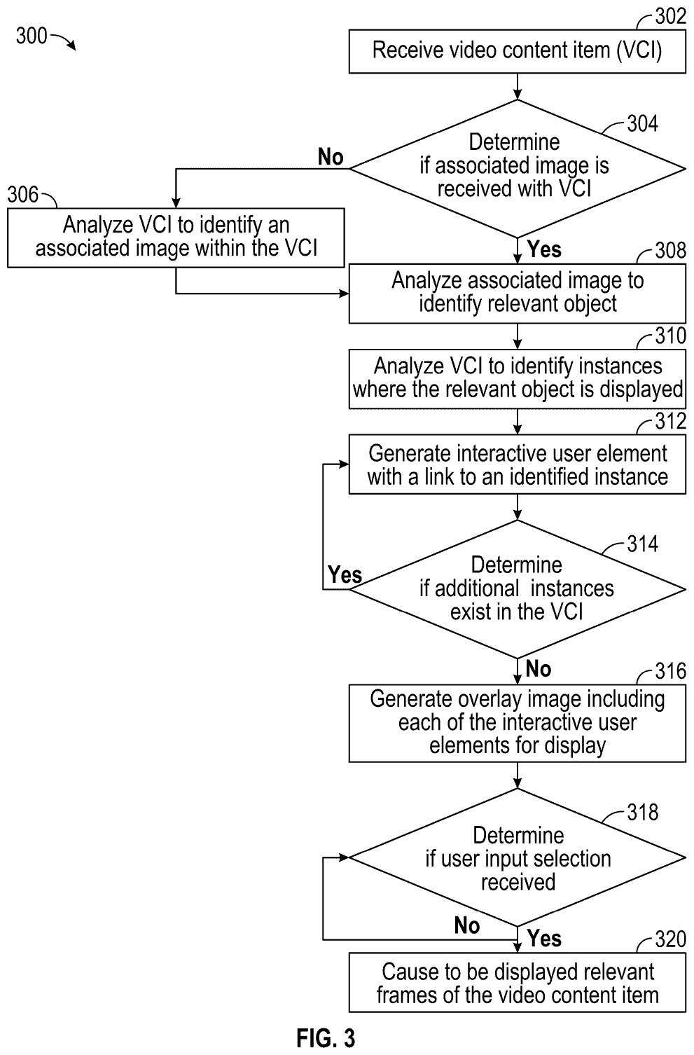

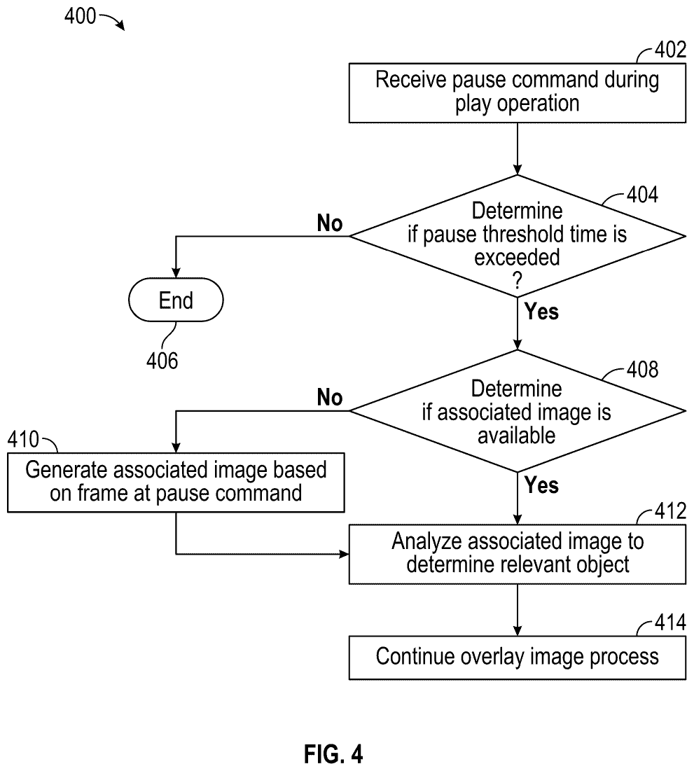

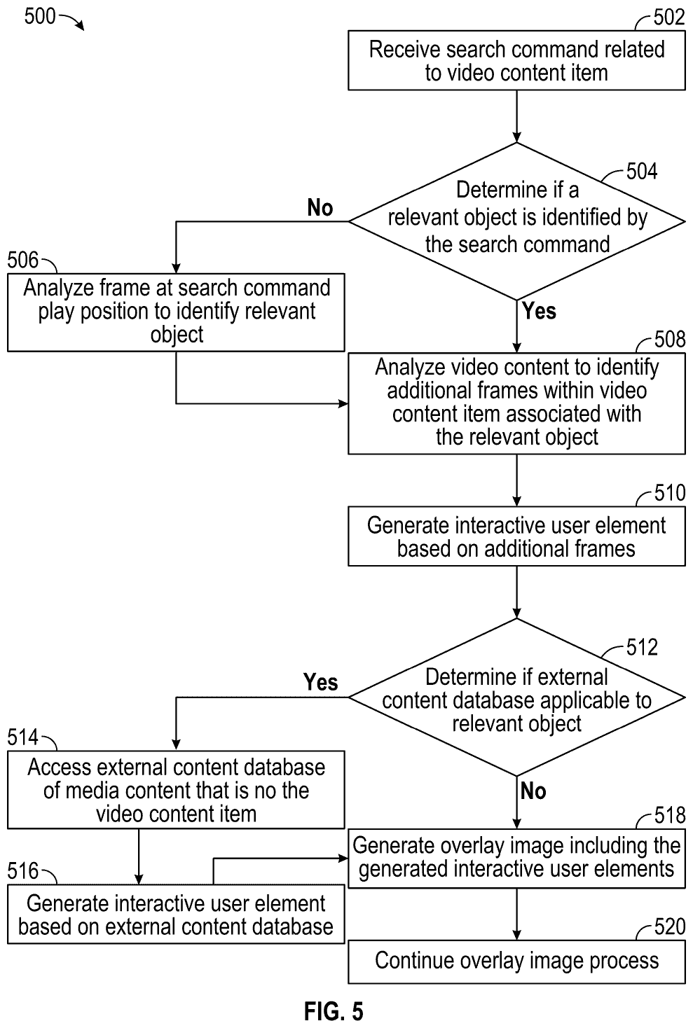

FIG. 3 is a flowchart of an illustrative process 300 for generating for display an overlay image with interactive user elements, in accordance with some embodiments of the disclosure. It should be noted that process 300 may be performed by control circuitry 806 of FIG. 8 and may be performed on any of user devices 202 and 204 and media server 206 of FIG. 2. In addition, one or more steps of process 300 may be incorporated into or combined with one or more steps of any other process or embodiment (e.g., process 400 of FIG. 4 and process 500 of FIG. 5). The process 300 may be performed in accordance with the embodiments discussed in connection with FIGS. 1A-1C.

At block 302, a file sharing service server, such as a video streaming server, receives an upload of a media content item from a user device. In an embodiment, the process 300 is initiated when an upload of a video content item is detected, e.g., by the video streaming server. At block 304, the server determines if an associated image is received with the video content item. For example, a thumbnail picture, a representative screenshot, an illustrated image, and the like may be uploaded, e.g., from the user device, along with the video content item and received by the video streaming server. If an associated image is received, the process continues with block 308, otherwise the process continues with block 306.

At block 306, the server analyzes the video content item to identify an associated image within the video content item. For example, video frames that make up the video content item can be analyzed, e.g., using image recognition, to determine a representative frame within the video frames, where the representative frame is assigned as an associated image. In a further embodiment, an image is accessed from an external source, e.g., an image database, that is determined to be a representative image of the media content item. In yet a further embodiment, the server analyzes the video content item and extracts relevant objects based on computer vision, metadata associated with the video content item, a transcript of the audio of the video content item, and the like, and generates a compound image based on any extracted data. The server may also generate a new image using generative artificial intelligence based on data extracted from the video content item, such as generated or externally accessed video transcripts or synopses.

At block 308, the server analyzes the associated image, namely the associated image that is either received, generated, or accessed, to identify a relevant object depicted therein. In an embodiment, the analysis may include analyzing the associated image to determine all relevant objects or a most likely relevant object depicted in the image. As an illustrative example, the subject of the video content item may be a review of a plurality of camera lenses, and the associated image may be a thumbnail displaying all the lenses discussed within the review. See FIG. 6 below.

At block 310, the server identifies instances within the video content item that are relevant to the identified relevant object. In an embodiment, the image and the video content item are analyzed by the server together to determine one or more objects that are relevant objects. In an embodiment, the analysis of both or either of the associated image and of the video content item may employ computer vision or machine learning models, such as a convolutional neural network (CNN) or You Only Look Once (YOLO) algorithms optimized for image recognition. In a further embodiment, a computer vision library, such as OpenCV or relevant Python libraries, are employed in analyzing the video content item and relevant images. The analysis may further include generating metadata for the detected relevant objects, including data describing an object's color, shape, location within a video frame, and the like. Additionally, subtitles, closed captioning, audio, and other elements of the video content item may be referenced in identifying objects depicted therein. The identified instances may include frames or segments within the video content item determined to be relevant to the identified relevant object. Continuing with the example discussed above, if the subject of the video content item is a review of a plurality of camera lenses and the associated image is a thumbnail displaying all the lenses discussed within the review, the identified instances are segments within the review that address each of the plurality of camera lenses. In an embodiment, an index, data, or data structure are generated when analyzing the video file, and the index or data is stored, e.g., in a database that can then be accessed and searched on-demand when a pause and/or search command is received from a user device.

At block 312, the server generates one or more interactive user elements based on the identified object and relevant frames within the video content item. The interactive user elements include a digital reference, such as a hyperlink, to a relevant instance or location. The relevant location may include one or more frames within the video content item, one or more frames within a different video content item, such as a video hosted on the same video service of the uploaded video content item or hosted on a different video service, an external source such as a webpage, an application, or any location determined to be relevant to the identified object. In an embodiment, the interactive user element is configured to be a visual or textual icon that can be interacted with when displayed on a user interface, e.g., selected or clicked on via a user input device such as a keyboard, mouse, touchscreen, voice recognition device, and the like.

At block 314, the server determines if any additional instances relevant to the identified relevant object or objects are present within the video content item, and if so, the process returns to step 312 where an interactive user element is generated based on the additional relevant instance. If not, the process continues with step 316.

At block 316, the server generates for display an overlay image including the one or more interactive user elements. In an embodiment, the overlay image includes one interactive user element for each identified relevant object. The overlay image may include the original accessed image or a different image along with the interactive user elements depicted thereon. In one embodiment, two or more interactive user elements with hyperlinks directed to video frames within the uploaded video content item are displayed in chronological order within the overlay image. In another embodiment, the two or more interactive user elements are ordered according to a popularity ranking of each relevant segment of the video content item. In a further embodiment, the interactive user elements are visually highlighted within the overlay image. Visual highlights include a border, higher or lower opacity than a background image, enlarged text within the interactive user element, and the like. The generated overlay image may be caused to be displayed on a user device, e.g., a consuming user device displayed the video content item.

At block 318, the server determines if a user input selection has been received, e.g., from the consuming user device. As discussed above regarding block 312, the interactive user element may be configured to be a visual or textual icon that can be interacted with when displayed on a user interface. For example, the user interface input may include a click, a tap, voice command, a hover, or a similar selection within a user interface, e.g., on a user device that is displaying the video content item.

At block 320, the referenced relevant video frames are caused to be displayed on the consuming user device in response to receiving the user interface input selection of the interactive user element.

FIG. 4 is a flowchart of a process 400 of generating for display an overlay image with interactive user elements in response to receiving a pause command, in accordance with some embodiments of the disclosure. In an embodiment, at block 402 a media server received a pause command during a play operation. For example, while a video is being streamed from a video streaming service for display on a user device, a pause command may be received on the user device, e.g., a pause command may be initiated via a user input device such as a touchscreen, a keyboard stroke, a mouse click, a remote button press, a voice command, a device sensor, and the like.

At block 404, the server determines if a pause threshold time has been exceeded. For example, a predetermined time period of inactivity may be set at five seconds. Once a pause command is received, it is determined if any further commands have been received for the duration of the predetermined time period. If additional commands or user activity are detected within the predetermined time period, the process ends at 406 and no further steps are taken. If the predetermined time period transpires without further commands or user activity detected, the process continues with block 408.

At block 408, the server determines if an associated image is available. As associated image may include an associated image received along with an initial upload of the video content item, as discussed above regarding FIG. 3. If an associated image is available, the process continues with step 412. If no associated image is available, the process continues with block 410, where the server generates or identifies an associated image. In an embodiment, the associated image is generated based on a video frame from the video content item. In an embodiment, the video frame is the frame being displayed when the pause command is received. In a further embodiment, a nearby frame, for example a keyframe, or a frame that is predetermined to contain an object of potential interest, is the video frame that is accessed. The accessed frame is analyzed, e.g., using image recognition techniques discussed herein, to determine a relevant object depicted therein.

At block 412, the server analyzes the associated image to determine a relevant object, as discussed in further detail above with reference to block 310. For example, if the subject of the video content item is a review of a plurality of camera lenses, and the associated image displayed one of the plurality of lenses, all other frames, or all other segments, within the video content item that relate to that lens are identified. In an embodiment, the analysis includes referencing a previously generated index or data structure related to the video, e.g., as discussed above regarding FIG. 1B, where the index or data structure is used to generate an interactive user element. The generated index or data structure may be stored in a database and accessed on demand. In a further embodiment, the index or data structure includes previously generated interactive user elements that are displayed when a pause command is received.

At block 414, the process for generating and displaying an overlay image continues, e.g., as described above regarding blocks 316-320 of FIG. 3.

FIG. 5 is a flowchart of a process 500 of generating for display an overlay image with interactive user elements in response to receiving a search command, in accordance with some embodiments of the disclosure. The process may be performed by a media server, or an application executed by control circuitry of a user device, a media server, and the like. At block 502, the server receives a search command related to a video content item. A search command may include receiving a user input command from a user device, such as the selection of a search graphical button on a video player display. The search command may be initiated via a user input device such as a touchscreen, a keyboard stroke, a mouse click, a remote button press, a voice command, a device sensor, and the like. As an example, a user device displays an image of a movie poster that depicts three actors starring in the movie. A user input selecting one of the actors displayed, e.g., via a click, a tap, voice command, a hover, or a similar selection within a user interface, is received as a search command to initiate the process of generating additional relevant information regarding that actor.

At block 504, the server determines if a relevant object is identified by the search command. For example, if a frame of the video content item contains multiple objects and the search command allows for selection of a portion of a frame containing only a single object, it is determined that the search command includes an identification of a relevant object. If a relevant object is identified by the search command, the process continues at block 508, otherwise the process continues at block 506.

At block 506, the server analyzes a frame being displayed at a user device, e.g., when the search command is received, to identify a relevant object. In a further embodiment, a nearby frame, e.g., a frame determined to be a relevant frame within a predetermined length of time, e.g., five seconds, of the displayed frame at which the search command is received is additionally analyzed to determine a relevant object.

At block 508, the server analyzes the video content item to identify other relevant instances or frames that are associated with the relevant object. For example, if the subject of the video content item is a review of a plurality of camera lenses, and the frame at which the search command is received shows one of the plurality of lenses, all other frames, or all other segments, that relate to that lens within the video content item are identified. In an embodiment, the analysis includes referencing or searching a previously generated index or data structure stored related to the video content item, e.g., as discussed above regarding FIG. 1B, where the index or data structure is used to generate an interactive user element. The generated index or data structure may be stored in a database and accessed on demand. In a further embodiment, the index or data structure includes previously generated interactive user elements that are displayed when a search command is received.

At block 510, the server generates an interactive user element based on the identified relevant instances or frames, as discussed further above regarding block 312 of FIG. 3.

At block 512, the server determines if an external content database is applicable to the identified relevant object. In an embodiment, an external database containing content or metadata related to content that is not the video content item being analyzed is accessed. Continuing with the camera lens review example discussed above, the content database may include metadata relating to external webpages not related to a video streaming service, such as lens review webpages, websites of camera equipment retailers, advertisements for tutorials related to camera equipment, and the like. If the external content database is determined to be applicable, the process continues with block 514, otherwise the process continues with block 518.

At block 514, the server accesses the external content database, where the external content database contains content or metadata relating to content that is not the video content item, and at block 516, an interactive user element is generated based on the external content database, e.g., identified related frames of other video content items and/or relevant documents, links, webpages, and the like identified from the external content database.

At block 518, the server generates an overlay image including the generated interactive user elements and the overlay image process continues e.g., as described above regarding blocks 316-320 of FIG. 3.

In each of the processes discussed in FIGS. 3-5, one or multiple interactive user elements may be generated and displayed within the overlay image. Additionally, in any of the disclosed embodiments discussed herein, the interactive user elements may include bookmarks, digital references, hyperlinks, and the like to (a) frames within the video content item, (b) external content that is not included in the video content, or (c) both. Additionally, in each of the processes discussed in FIGS. 3-5, the blocks of the processes can be combined, rearranged, split, removed, added, or the like in a variety of manners. For example, accessing an external content database to determine if relevant content is found outside of the platform and used in the generation of interactive user elements may or may not implemented in any of the processed discussed herein. Further, an analysis of the video content item may be a) performed on demand, e.g., when a search or pause comment is received, b) previously performed, e.g., when file upload is received, and saved to an index or data structure that is stored and accessible in a database, or c) a combination of the performing a portion of the analysis at a prior time and a portion of the analysis on demand.

FIG. 6 depicts example thumbnail images 602 and 604 of a video content item 600, in accordance with some embodiments of the disclosure. In illustrative thumbnail image 602, a plurality of camera lenses are shown as a representative graphic for a video review of some or all of the shown camera lenses. Such a thumbnail image may be an example of the associated image referenced in block 304 of FIG. 3, or the accessed frames of block 408 of FIG. 4 and block 504 of FIG. 5. Thumbnail image 602 may be an image uploaded to a video sharing server along with the associated video file, or generated as a screenshot or captured frame of the video file determined to be representative of the video file.

Thumbnail image 604 is an example of an overlay image that includes interactive user elements 606 and 608, each highlighted by a dashed border around an identified relevant object. Interactive user element 606 and 608 are illustrative examples, and some or each of the camera lenses depicted may be presented as an interactive user element. Additionally, images of related content or of lenses not shown in the thumbnail image 602 may be displayed as additional interactive user elements, as shown in FIGS. 1A-1C. Thumbnail image 604 may be a generated overlay image output by the processed discussed herein. The overlay image is configured to be interactive, where a user input selection of a particular object, e.g., a click, a tap, a selection, and the like of a specific lens is received, and in response to the user input selection, a relevant portion of the video content item or relevant external content related to the specific lens is displayed on a user device.

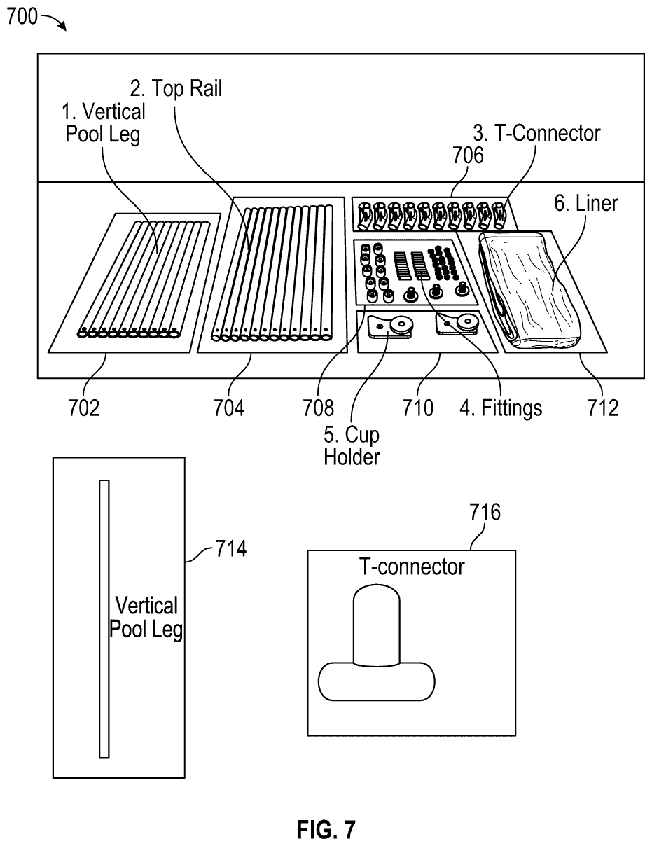

FIG. 7 depicts illustrative thumbnail images 700 of a video content item with distorted and non-distorted images of relevant objects, in accordance with some embodiments of the disclosure. In the image 700, a thumbnail of a video review for a pool assembly is shown. The thumbnail 700 may be a generated overlay image output as described above in the processes discussed in FIGS. 3-5. Multiple parts of the pool assembly are shown, including vertical pool legs 702, top rail segments 704, T-connectors 706, fittings 708, cup holders 710, and a liner 712. In an embodiment, image 700 is a video frame from a review video, or an uploaded image accessed along with an uploaded video file of the review.

In an embodiment each of the relevant objects displayed in a thumbnail of a video content item is highlighted and a corresponding interactive user element is generated. For example, one or more of the multiple parts of the pool assembly shown in image 700 may be identified as relevant objects and an interactive user element is generated for each part or collection of parts. In response to receiving a user input selection of one of the interactive user elements, one or more segments of the video content item is displayed on a user device. For example, if a user input selection of the liner 712 is received, the segment of the video content item demonstrating the installation process of the liner 712 is displayed.

The items displayed in the image are shown as distorted, e.g., displayed with a keystone distortion effect. In an embodiment, the generation of interactive user elements discussed herein includes generating a corrected image of an identified object, such as the corrected image of the vertical pool leg 714 or the T-connector 716. The corrected image can be used as the graphical representation of the interactive user element and displayed in the generated overlay image. The corrected image may be generated using machine learning techniques, e.g., a convolutional neural network (CNN) optimized for image recognition, an artificial intelligence image generator, such as Dall-E, OpenAI tools, and the like. In a further embodiment, if relevant objects within an image are determined to be distorted, a reference image of that item from a database, e.g., a stock image of the object accessed from a product inventory, is used as a non-distorted version of the object. In an embodiment, metadata associated with the video content item, such as SKU numbers of objects depicted therein, is accessed and used to identify relevant objects within the video content item.

FIG. 8 is a block diagram showing components of a device 800 for generating for display an overlay image with interactive user elements, in accordance with some embodiments of the disclosure. The device 800 may represent an example of any one or more of devices 102, 104, 114, 122, 134, 142, 154, 202, 204, 206, or 208, in some embodiments, and it may perform the same or similar functionality described with respect to said devices (e.g., the functionality described with respect to the methods discussed in connection with FIGS. 1A-5). Device 800 is depicted having components that are internal and external to device 800, for example, processing circuitry 806, storage 808, and communications circuitry, such as a network interface 802, e.g., Wi-Fi radio, mobile network telecommunication radio, e.g., LTE, 5G, and the like. In some embodiments, each of the devices described herein may comprise some or all of the components of device 800.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), GPUs, etc., and may include multiple parallel processing cores or redundant hardware. In some embodiments, processing circuitry 806 may be distributed across multiple separate processors or processing units, for example, multiple of the same type of processors or multiple different processors. In some embodiments, control circuitry 804 executes instructions stored in memory (e.g., storage 808) and/or other non-transitory computer readable medium. Specifically, control circuitry 804 may be instructed to perform the functions discussed above and below. For example, a device (e.g., any of devices 102, 104, 114, 122, 134, 142, 154, 202, 204, 206, or 208) may execute or comprise the code required to execute instructions associated with at least a portion of device configured to generate for display an overlay image with interactive user elements and may provide instructions to control circuitry 804 to cause the output of an overlay image.

In some embodiments, control circuitry 804 may include communications circuitry (e.g., Wi-Fi radio and/or mobile radio and/or an NFC radio) suitable for communicating with other networks (e.g., a LAN or a WAN), servers (e.g., a server accessed via the), or devices. The instructions for carrying out the above-mentioned functionality may be stored on storage 808. The communications circuitry may include a modem, a fiber optic communications device, an Ethernet card, or a wireless communications device for communicating with other devices. Such communications may involve the internet or any other suitable communications networks or paths. In addition, communications circuitry may include circuitry that enables peer-to-peer communication between devices.

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, or any other suitable fixed or removable storage devices including non-transitory computer readable media for storing data or information, and/or any combination of the same. Storage 808 may be used to store various types of data herein, such as instructions for performing the methods described herein. Nonvolatile memory may also be used (e.g., to launch a boot-up routine and other instructions). Cloud-based storage (e.g., storage accessed via the Internet) may be used to supplement storage 808 or instead of storage 808.

The systems and methods described herein may be implemented using any suitable architecture. For example, the systems and methods described herein may be a stand-alone application wholly implemented on device 800. In such an approach, instructions of the application are stored locally (e.g., in storage 808). In some embodiments, the systems and methods described herein may be a client-server-based application. Data for use by a thick or thin client implemented on device 800 is retrieved on demand by issuing requests to a server remote from the device 800. In some embodiments, the systems and methods provided herein are downloaded and interpreted or otherwise run by an interpreter or virtual machine (run by control circuitry 804). In some embodiments, some functions are executed and stored on one device and some are executed and stored on a second device.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
accessing a video content item;
accessing an image associated with the video content item;
analyzing the video content item and the image to identify:
an object depicted in the image; and
a portion of frames of the video content item that are relevant to the object depicted in the image;
generating an interactive user element based on the object depicted in the image;
generating for display an overlay image with the interactive user element; and
in response to a user interface input selection of the interactive user element, causing to be displayed at least the identified portion of the frames of the video content item that are relevant to the object depicted in the image.

2. The method of claim 1, wherein accessing the video content item comprises receiving, at a video sharing server, an upload of a video file from a first user device;
wherein accessing the image comprises receiving, at the video sharing server, a proposed thumbnail for the video content item;
wherein analyzing the video content item and the image is performed in response to receiving (1) the upload of the video file and (2) the proposed thumbnail; and
wherein generating for display the overlay image with the interactive user element comprises modifying the proposed thumbnail to display, at a second user device, the interactive user element together with the proposed thumbnail.

3. The method of claim 2, wherein receiving the proposed thumbnail further comprises receiving, at the video sharing server, an upload of an image file from the first user device.

4. The method of claim 1, wherein accessing the video content item comprises detecting, from a user device, a pause command during a play operation of the video content item and determining a video file associated with the video content item;
wherein accessing the image comprises determining a video frame of the video file at a play position of the video content item where the pause command is detected;
wherein analyzing the video content item and the image is performed in response to detecting the pause command; and
wherein generating for display the overlay image with the interactive user element comprises modifying the video frame to display, on the user device, the interactive user element together with the video frame.

5. The method of claim 4, wherein the analyzing the video content item and the image is performed when the video content item is determined to be a paused state for a predetermined threshold of time.

6. The method of claim 1, wherein accessing the video content item comprises detecting, from a user device, a search command during a play operation of the video content item and determining a video file associated with the video content item;
wherein accessing the image comprises determining a video frame of the video file at a play position of the video content item where the search command is detected;
wherein analyzing the video content item and the image is performed in response to detecting the search command; and
wherein generating for display the overlay image with the interactive user element comprises modifying the video content item to display, on the user device, the overlay image superimposed on top of the video content item.

7. The method of claim 1, wherein the overlay image comprises at least two interactive user elements depicting two or more objects, wherein each of the two or more objects relates to a relevant video frame of the video content item; and
wherein each of the at least two interactive user elements is a hyperlink to a playback position within the video content item.

8. The method of claim 7, wherein the at least two interactive user elements are displayed within the overlay image in chronological order in which they appear in the video content item.

9. The method of claim 1, further comprising:
accessing a content database comprising metadata related to media content that is not the video content item, wherein the metadata includes location data for the media content; and
searching the content database for media content relevant to the object depicted in the image,
wherein the overlay image comprises an interactive user element that is a hyperlink to a location of a media content of the content database based on the location data.

10. The method of claim 1, further comprising:
determining that the object depicted in the image is distorted; and
generating a non-distorted version of the object using generative artificial intelligence, wherein the interactive user element of the overlay image includes the non-distorted version of the object.

11. The method of claim 1, wherein the overlay image with the interactive user element is caused to be displayed over the video content item during a play operation of the video content item.

12. The method of claim 1, further comprising:
generating an index referencing the generated interactive user element; and
storing the generated index in a database, wherein the overlay image is generated based on the accessed generated index.

13. The method of claim 12, wherein the generated index is accessed and the overlay image is caused to be displayed in response to receiving an interface command comprising at least one of a pause command, a search command or a play command.

14. A system for enabling user-specific real-time information services for identifiable objects in a media stream, the system comprising:
control circuitry configured to:
access a video content item;
access an image associated with the video content item;
analyze the video content item and the image to identify:
an object depicted in the image; and
a portion of frames of the video content item that are relevant to the object depicted in the image;
generate an interactive user element based on the object depicted in the image;
generate for display an overlay image with the interactive user element; and
in response to a user interface input selection of the interactive user element, cause to be displayed at least the identified portion of the frames of the video content item that are relevant to the object depicted in the image.

15. The system of claim 14, wherein accessing the video content item comprises receiving, at a video sharing server, an upload of a video file from a first user device;
wherein accessing the image comprises receiving, at the video sharing server, a proposed thumbnail for the video content item;
wherein analyzing the video content item and the image is performed in response to receiving (1) the upload of the video file and (2) the proposed thumbnail; and
wherein generating for display the overlay image with the interactive user element comprises modifying the proposed thumbnail to display, at a second user device, the interactive user element together with the proposed thumbnail.

16. The system of claim 15, wherein receiving the proposed thumbnail further comprises receiving, at the video sharing server, an upload of an image file from the first user device.

17. The system of claim 14, wherein accessing the video content item comprises detecting, from a user device, a pause command during a play operation of the video content item and determining a video file associated with the video content item;
wherein accessing the image comprises determining a video frame of the video file at a play position of the video content item where the pause command is detected;
wherein analyzing the video content item and the image is performed in response to detecting the pause command; and
wherein generating for display the overlay image with the interactive user element comprises modifying the video frame to display, on the user device, the interactive user element together with the video frame.

18. The system of claim 17, wherein the analyzing the video content item and the image is performed when the video content item is determined to be a paused state for a predetermined threshold of time.

19. The system of claim 14, wherein accessing the video content item comprises detecting, from a user device, a search command during a play operation of the video content item and determining a video file associated with the video content item;
wherein accessing the image comprises determining a video frame of the video file at a play position of the video content item where the search command is detected;
wherein analyzing the video content item and the image is performed in response to detecting the search command; and
wherein generating for display the overlay image with the interactive user element comprises modifying the video content item to display, on the user device, the overlay image superimposed on top of the video content item.

20. The system of claim 14, wherein the overlay image comprises at least two interactive user elements depicting two or more objects, wherein each of the two or more objects relates to a relevant video frame of the video content item; and
wherein each of the at least two interactive user elements is a hyperlink to a playback position within the video content item.

21-27. (canceled)
